(19) United States
(12) Patent Application Publication
(10) Pub. No.: US 2013/0128401 A1
(43) Pub. Date: May 23, 2013

(54) NETWORK COMMUNICATION DEVICE AND PRINTED CIRCUIT BOARD WITH TRANSIENT ENERGY PROTECTION THEREOF

(71) Applicant: REALTEK SEMICONDUCTOR CORP., HsinChu (TW)

(72) Inventors: Tay-Her Tsaur, Tainan City (TW); Cheng-Cheng Yen, Hsinchu City (TW)

(73) Assignee: REALTEK SEMICONDUCTOR CORP., HsinChu (TW)

(21) Appl. No.: 13/682,041

(22) Filed: Nov. 20, 2012

(30) Foreign Application Priority Data
Nov. 21, 2011 (TW) 100142615

(51) Int. Cl. H01T 4/00

(52) U.S. Cl. CPC H01T 4/00
USPC 361/56

(57) ABSTRACT

A network communication device and printed circuit board are provided with transient energy protection. The network communication device includes a transceiver, a transformer, a connector, a spark gap, and a transient energy trigger circuit. The transformer is coupled between the transceiver and the connector. The spark gap and the transient energy trigger circuit are coupled in parallel, between the transformer and a ground end. Alternatively, the spark gap and the transient energy trigger circuit are coupled in parallel, between any two of differential signal lines of the transformer. The spark gap and the transient energy trigger circuit provide a multi-path structure for conducting away the transient energy. A first transient energy is conducted to the ground end through the transient energy trigger circuit, while a second transient energy is conducted to the ground end through the spark gap.

### CROSS-REFERENCES TO RELATED APPLICATIONS

This non-provisional application claims priority under 35 U.S.C. §119(a) on Patent Application No. 100142615 filed in Taiwan, R.O.C. on Nov. 21, 2011, the entire contents of which are hereby incorporated by reference.

### BACKGROUND

1. Technical Field

The disclosure relates to a communication device, and more particularly to a network communication device and print circuit board thereof with transient energy protection.

2. Related Art

A previous Ethernet standard established by IEEE (Institute of Electrical and Electronics Engineers) is IEEE “10BASE5” in IEEE 802.3. The major definition for this standard is: “10” represents the transmission speed is 10 Mbps; “BASE” means baseband signals are utilized in this standard for transmission purposes; “5” means the distance between every network node is at most 500 meters. Afterwards, IEEE further establishes IEEE 802.3u, which is a 100BASE-T standard supporting 100 Mbps transmission speed. The Gigabit network speed 1,000 Mbps well known nowadays represents “Gigabit Ethernet”.

FIG. 1 is an explanatory framework diagram of a conventional Ethernet communication device; in which a transformer 30 is coupled between a transceiver 20 and a connector 40, and connector 40 is connected with other network apparatuses. Since the remote network apparatus connected with transceiver 20 and connector 40 will have a voltage level difference due to long-distance transmission, transformer 30 is required to transform the voltage levels.

Usually a network apparatus could be damaged by interferences of “transient energy”. Therefore, Electrostatic Discharge (ESD) Test, Electrical Fast Transient/Burst (EFT/Burst) Test and Surge Test are necessary to evaluate the capability of an electrical apparatus zapping by transient energy.

(1) ESD Test: Positive/negative charges may be generated by friction or induction and be accumulated in the human body or circuit components. When these charges are accumulated to have a sufficient voltage level difference from the surrounding environment, electrostatic discharge occurs and generates a discharge voltage with a temporary high current, which could cause damages or malfunctions of the circuit components inside an electrical apparatus. The purpose of ESD Test is to assess the protection capability and sensibility of an IC product when electrostatic discharge is conducted from the human body or apparatus, through IC pins into the interior of IC product upon transportation and operation.

(2) EFT/Burst: When an inductive loading (e.g. a relay, a contactor etc.) is disconnected, due to insulating/dielectric breakthrough or a contact bounce at the switch contact gap, transient disturbances could be generated at the disconnection point. EFT is to test the protection capability when the tested apparatus is operated with a power source with pulse noises.

(3) Surge Test (also known as Lightning Test): When a lightning impacts on an electricity system or a communication line, tremendous transient over-voltage or over-current (usually called “Surge” or “Impact”) may be generated. A surge may possibly generate instant voltages from hundreds to tens of thousands volts, or instant high currents from hundreds to over one thousand amp. The purpose of the surge test is to inspect the protection capability of electrical/electronic apparatuses from the surges.

Since a network apparatus is not only connected with a general electronic systems, but also connected with remote devices through long-distance communication lines, capabilities of resisting the mentioned transient energy is required for a network apparatus.

### SUMMARY

According to an embodiment of the disclosure, a network communication device with transient energy protection is provided. The network communication device includes a transformer, a connector, a transient energy trigger circuit and a spark gap. The transformer is coupled to a transceiver. The connector is coupled to the transformer. The transient energy trigger circuit is coupled between the transformer and a ground end. The spark gap is coupled in parallel with the transient energy trigger circuit. At a first state the transient energy trigger circuit dissipates a first transient energy to the ground end; and at a second state the spark gap dissipates a second transient energy to the ground end; wherein the second transient energy is greater than the first transient energy.

In another embodiment, a printed circuit board applicable on a network communication device. The network communication device includes a transceiver, a connector and a transformer coupled between the transceiver and the connector. The printed circuit board includes a transient energy trigger circuit and a spark gap. The transient energy trigger circuit is coupled between the transformer and a ground end. The spark gap is coupled in parallel with the transient energy trigger circuit. At a first state the transient energy trigger circuit dissipates a first transient energy to the ground end; and at a second state the spark gap dissipates a second transient energy to the ground end; wherein the second transient energy is greater than the first transient energy.

In another embodiment, a network communication device with transient energy protection is provided. The network communication device includes a transformer, a connector, a transient energy trigger circuit and a spark gap. The transformer is coupled to a transceiver; the connector is coupled to the transformer; the transient energy trigger circuit; and the spark gap is coupled in parallel with the transient energy trigger circuit between two ends of a primary side of the transformer or between another two ends of a secondary side of the transformer. At a first state, the transient energy trigger circuit dissipates a first transient energy to the ground end; and at a second state the spark gap dissipates a second transient energy to the ground end; wherein the second transient energy is greater than the first transient energy.

In another embodiment, a printed circuit board is applicable to a network communication device. The network communication device includes a transceiver, a connector and a transformer coupled between the transceiver and the connector. The printed circuit board includes a transient energy trigger circuit and a spark gap coupled in parallel with the transient energy trigger circuit between two ends of a primary side of the transformer, or between another two ends of a secondary side of the transformer. At a first state the transient energy trigger circuit dissipates a first transient energy to the ground end; and at a second state the spark gap dissipates a second transient energy to the ground end; the second transient energy is greater than the first transient energy.

Variously, a second transient energy trigger circuit may be used to couple in parallel with the transient energy trigger circuit and the spark gap.

The disclosure couples the spark gap and the transient energy trigger circuit in parallel. When the transient energy is lower, it may be dissipated through the transient energy trigger circuit; when the transient energy is higher, it may be dissipated through the spark gap. Such dual-path design highly enhances the effects of protecting the electrical system.

### BRIEF DESCRIPTION OF THE DRAWINGS

The disclosure will become more fully understood from the detailed description given herein below for illustration only, and thus not limitative of the present invention, wherein:

FIG. 1 is an explanatory framework diagram of a conventional local network design;

FIG. 2A is an explanatory diagram of a first embodiment of a network communication device;

FIG. 2B is an explanatory diagram of surge voltages caused by transient energy;

FIG. 2C is an explanatory diagram of a network communication device with transient energy dissipated through a transient energy trigger circuit;

FIG. 2D is an explanatory diagram of a network communication device with transient energy discharged through a spark gap;

FIG. 3A is an explanatory diagram of a first embodiment of a transient energy trigger circuit;

FIG. 3B is an explanatory diagram of a second embodiment of a transient energy trigger circuit;

FIG. 3C is an explanatory diagram of a third embodiment of a transient energy trigger circuit;

FIG. 4A is an explanatory diagram of a first embodiment of a spark gap realized by PCB (Printed Circuit Board) layout;

FIG. 4B is an explanatory diagram of a second embodiment of a spark gap realized by PCB layout;

FIG. 4C is an explanatory diagram of a third embodiment of a spark gap realized by PCB layout;

FIG. 5 is an explanatory diagram of a second embodiment of a network communication device;

FIG. 6A is an explanatory diagram of a third embodiment of a network communication device;

FIG. 6B is an explanatory diagram of a network communication device with a line-to-ground surge test on a spark gap connected with a transient energy trigger circuit in parallel;

FIG. 6C is an explanatory diagram of a network communication device that applies a line-to-line surge test on a spark gap connected with a transient energy trigger circuit in parallel; and

FIG. 7 is an explanatory diagram of a fourth embodiment of a network communication device.

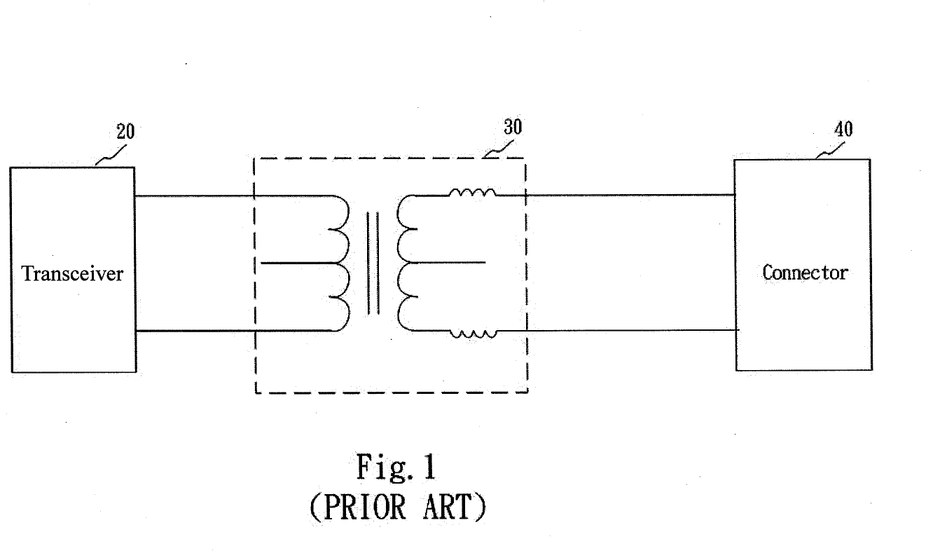

### DETAILED DESCRIPTION

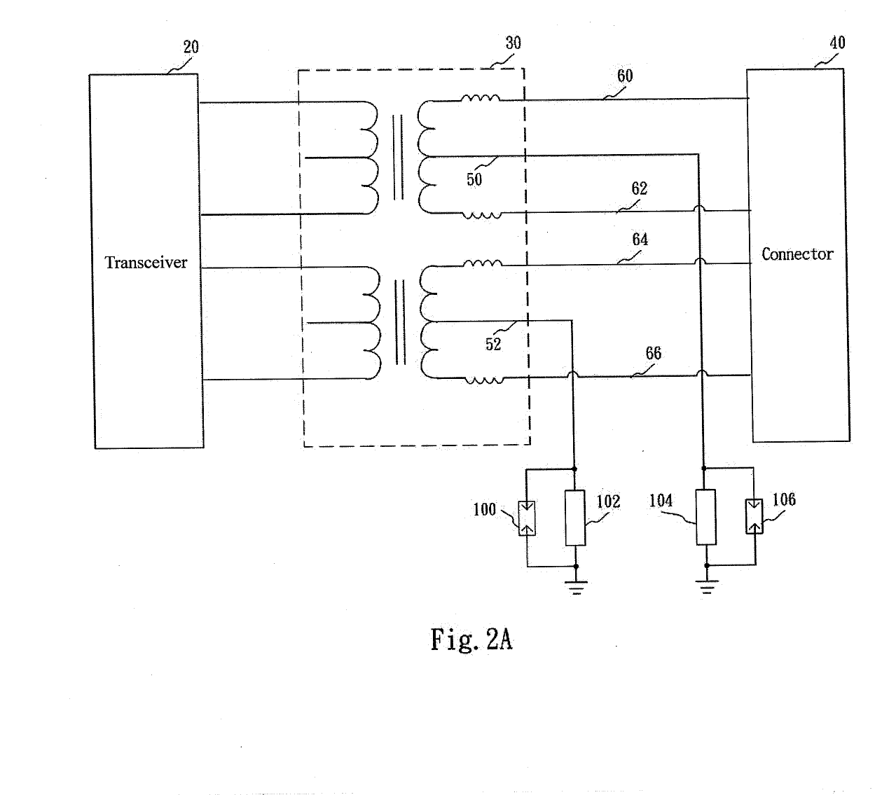

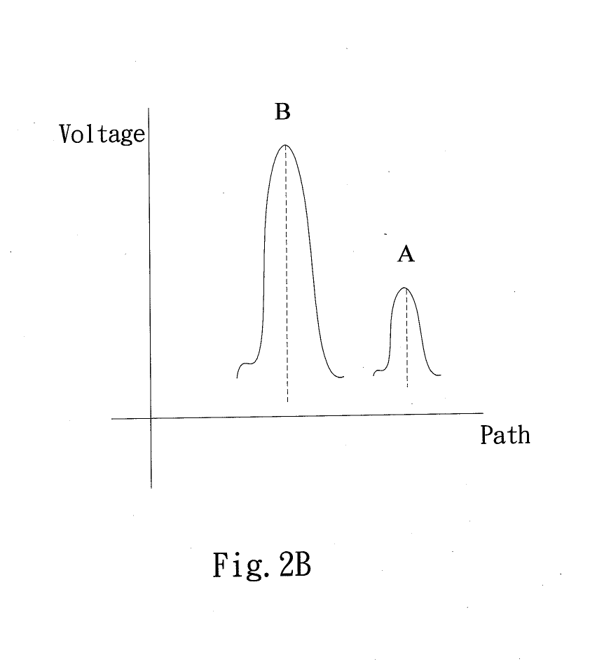

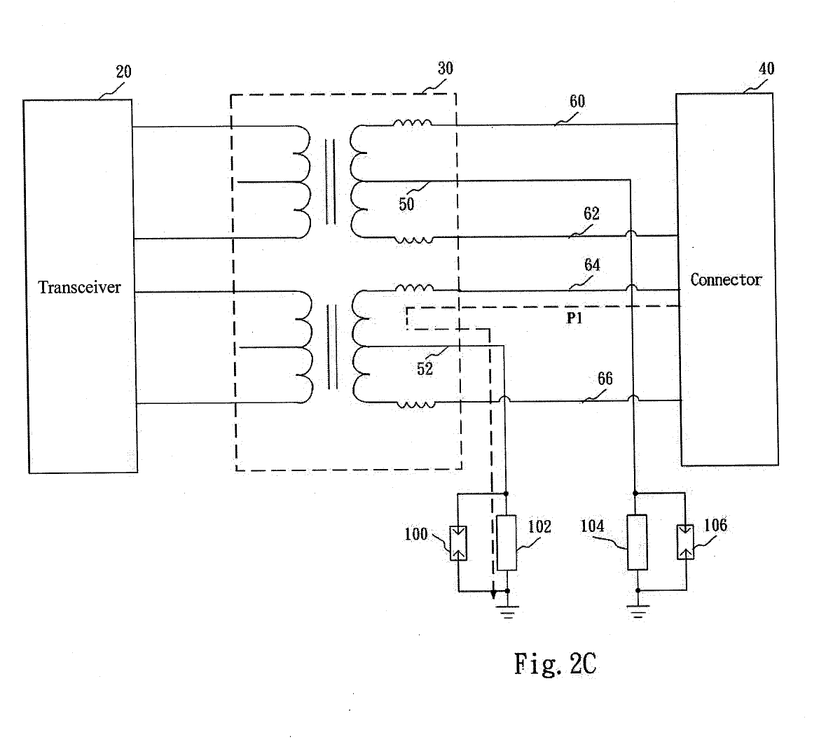

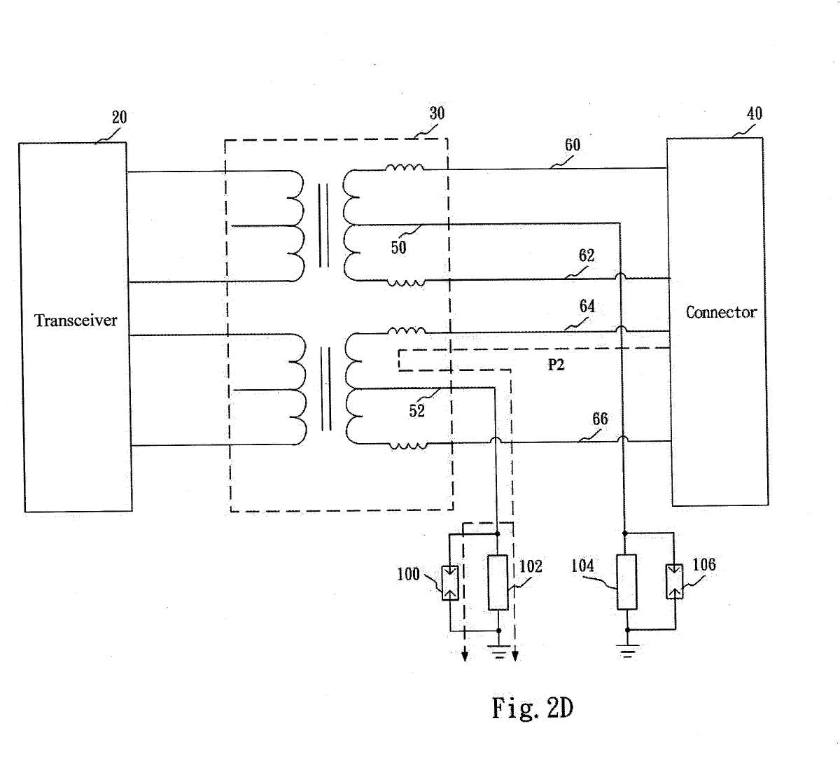

Please refer to FIG. 2A, which is an explanatory diagram of a first embodiment of a network communication device. A Transformer 30 is coupled between a transceiver 20 and a connector 40. Transformer 30 includes 2 coil sets: a secondary side of a first coil set includes a first differential signal line 60, a second differential signal line 62 and a first center tap 50; a secondary side of a second coil set includes a third differential signal line 64, a fourth differential signal line 66 and a second center tap 52. First differential signal line 60, second differential signal line 62, third differential signal line 64, and fourth differential signal line 66 are connected to connector 40. Each coil set of a primary side in transformer 30 is coupled to transceiver 20, while each coil set of a secondary side thereof is connected to connector 40. Transient energy trigger circuits 102/104 are respectively connected with spark gaps 100/106 in parallel between transformer 30 and a ground end. In the present embodiment, transient energy trigger circuit 102 is coupled with spark gap 100 in parallel between a second center tap 52 and the ground end; transient energy trigger circuit 104 is coupled with spark gap 106 in parallel between a first center tap 50 and the ground end. When transient energy is impacted into connector 40, transient energy trigger circuits 102 and 104 are able to conduct and dissipate lower transient energy to the ground end. When high transient energy is received, such high transient energy may be conducted and dissipated to the ground end through the sparking at spark gap 100/106. In the embodiments that the transformer has only one coil set or in other embodiments, a transient energy trigger circuit and a spark gap may be coupled in parallel between a center tap and the ground end. In some embodiments, the ground end may be realized by a metal housing or a digital ground end.

In the present embodiment, parallel circuits of spark gaps 100/106 and transient energy trigger circuits 102/104 are disposed between center taps 50/52 and the ground end and operated as multiple paths for energy dissipation during ESD test, EFT test or Surge test. When transient energy is input to the circuits through connector 40, even though the transient energy cannot generate sparking at the spark gaps, the transient energy trigger circuit may still dissipate the energy to the ground end, without being accumulated in the circuits to cause circuit damages or malfunctions.

The transient energy may be electrostatic discharge energy, electronic rapid transient pulse energy or Lightning energy. Comparing to the Lightning energy, generally the electrostatic discharge energy and the electronic rapid transient pulse energy are smaller and the surge voltage/current may be conducted to the ground through the transient energy trigger circuit.

FIG. 2B is an explanatory diagram of surge voltages caused by transient energy; wherein a second transient energy B is greater than a first transient energy A. In the embodiment of FIG. 2A, the first transient energy A may be dissipated to the ground through the transient energy trigger circuit; since the second transient energy B has higher energy enough to generate the sparking at the spark gap, the second transient energy B is dissipated to the ground through the spark gap and the transient energy trigger circuit.

FIG. 2C is an explanatory diagram of a network communication device with transient energy dissipated through a transient energy trigger circuit, in which the first transient energy A is conducted through a first dissipating path P1. When the first transient energy A enters a third differential signal line 64, the first transient energy A is conducted through the first dissipating path P1, namely inputting at connector 40, and being conducted sequently through the third differential signal line 64 of transformer 30, the second center tap 52, the transient energy trigger circuit 102 to the ground end.

Refer to FIG. 2D, which is an explanatory diagram of a network communication device with transient energy discharged through a spark gap. When the higher second transient energy B enters the third differential signal line 64, the second transient energy B inputs into connector 40, and is conducted sequently through third differential signal line 64 and second center tap 52, making the sparking at spark gap 100 and transient energy trigger circuit 102, and being conducted to the ground end for completing energy dissipation.

FIGS. 2C and 2D illustrated embodiments with the transient energy entering through the third differential signal line 64. When the transient energy enters from other differential signal lines of the connector, the corresponding dissipating paths may be similarly concluded without additional explanations.

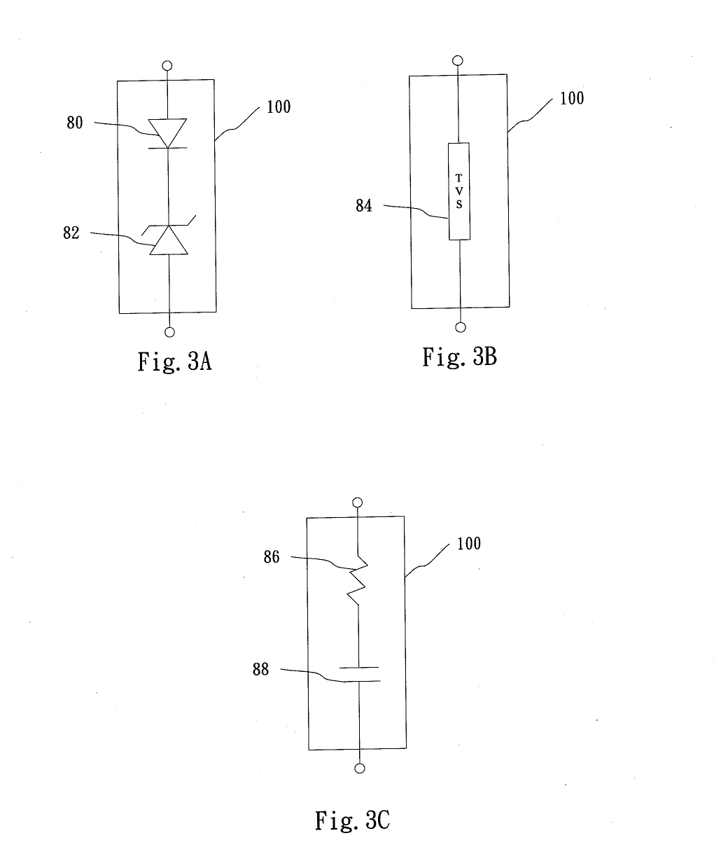

The transient energy trigger circuit may be realized by a gas tube, a TVS (Transient voltage suppression) diode, or a serial circuit with a diode and a Zener diode. Moreover, the transient energy trigger circuit may also realized by PCB (Print Circuit Board) layout. Please refer to FIG. 3A, which is an explanatory diagram of a first embodiment of a transient energy trigger circuit. Transient energy trigger circuit 100 consists of a diode 80 and a Zener diode 82. Diode 80 and Zener diode 82 is serially coupled between transformer 30 and the ground end. If a Zener diode 82 with an operating voltage at 50 volts is utilized, the transient energy may be conducted to the ground end through Zener diode 82 as long as the transient energy is higher than 50 volt.

Please refer to FIG. 3B, which is an explanatory diagram of a second embodiment of a transient energy trigger circuit. Transient energy trigger circuit 100 may include a TVS diode 84 to conduct the transient energy to the ground. In other embodiments, transient energy trigger circuit 100 may include a resistance 86 and a capacitance 88 serially coupled with each other, or include other circuit(s) or chip(s) that is conductible for the transient energy, as shown in FIG. 3C. The implementations for the transient energy trigger circuit mentioned above should not be considered as general limitations to the disclosure; the actual implementation of the transient energy trigger circuit should be selected and changed according to the actual application of the electrical system.

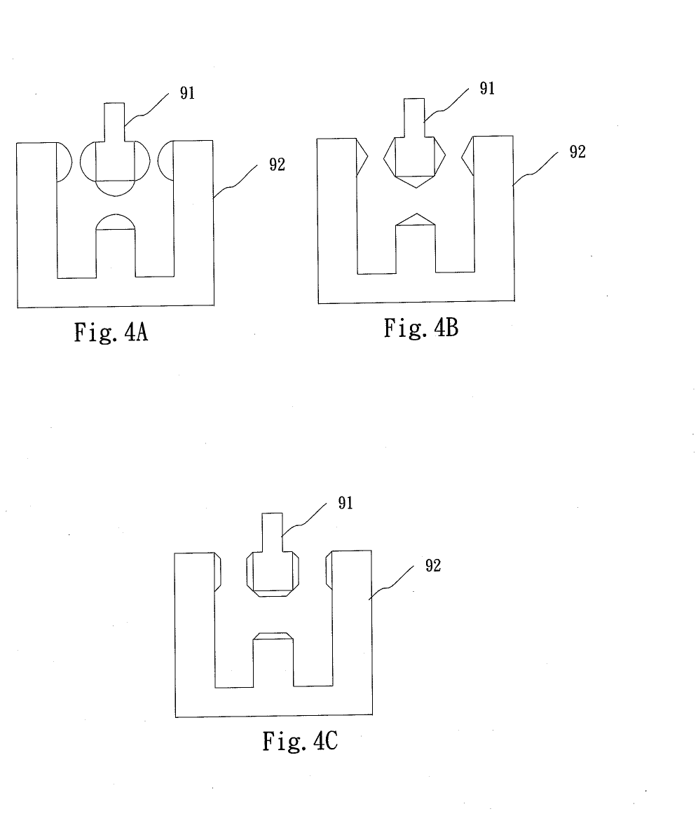

In some embodiments, the spark gap may be realized by a method of triple-electrode point-sparking. In addition, the spark gap may be disposed around a welding position of an electrical component; or the spark gaps may be disposed at three directions around the welding pad to provide multidirectional spark gap paths. The PCB shape of the spark gap may be a sharp tip, or a circular shape in FIG. 4A, a triangle shape in FIG. 4B and a trapezoid shape in FIG. 4C or any combination thereof.

Refer to FIGS. 4A, 4B and 4C, a first end 91 and a second end 92 of the spark tap may be respectively coupled to transformer 30 and the ground end, or respectively coupled to the two ends at the primary side or secondary side of transformer 30.

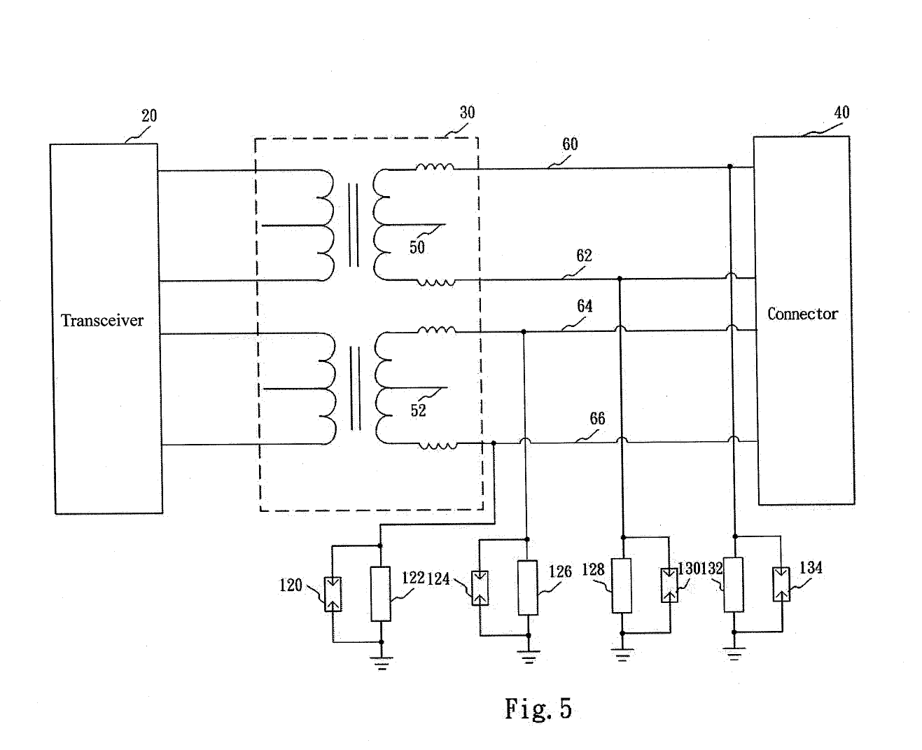

FIG. 5 is an explanatory diagram of a second embodiment of a network communication device. Transient energy trigger circuits 132, 128, 126, 122 are respectively coupled with spark gaps 134, 130, 124 and 120 in parallel between differential signal lines 60, 62, 64 and 66 and the ground end.

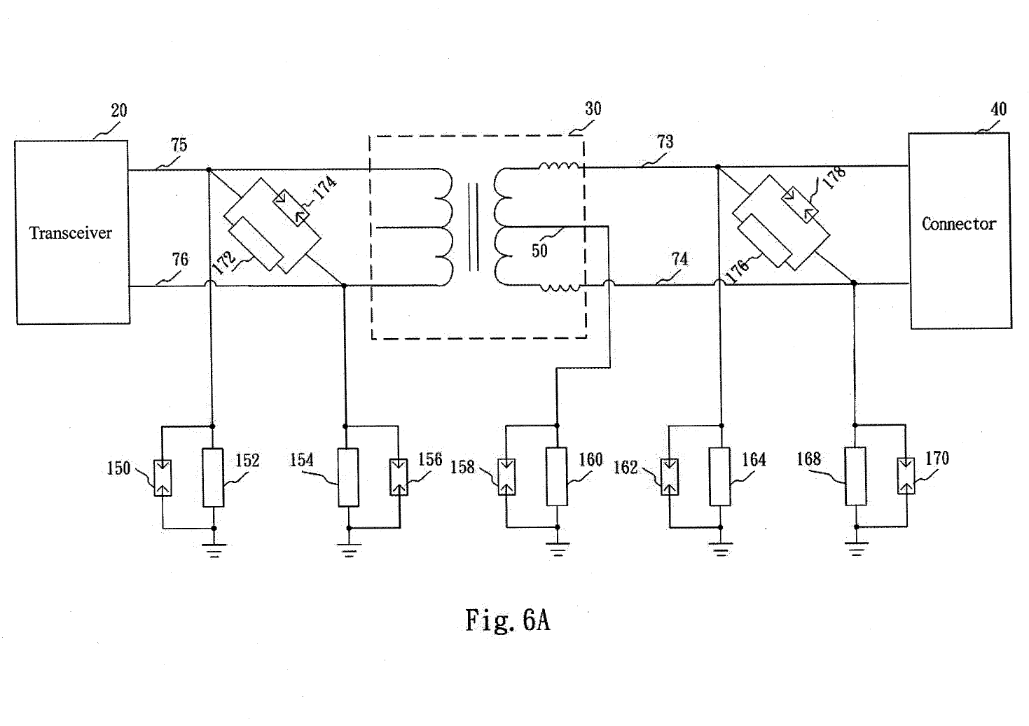

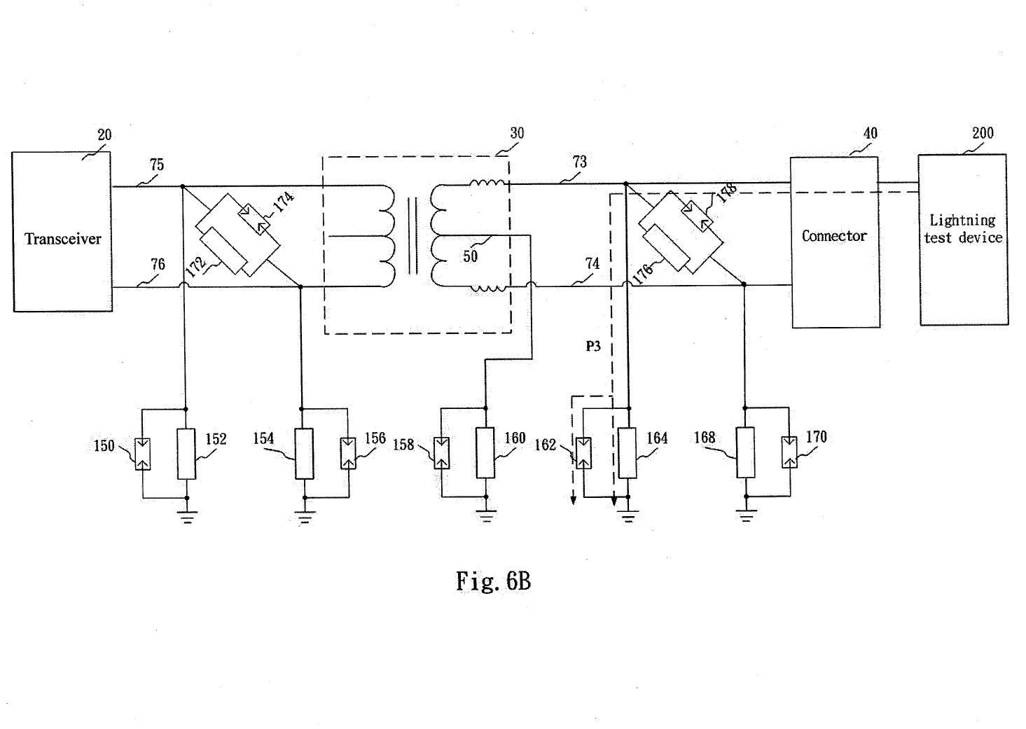

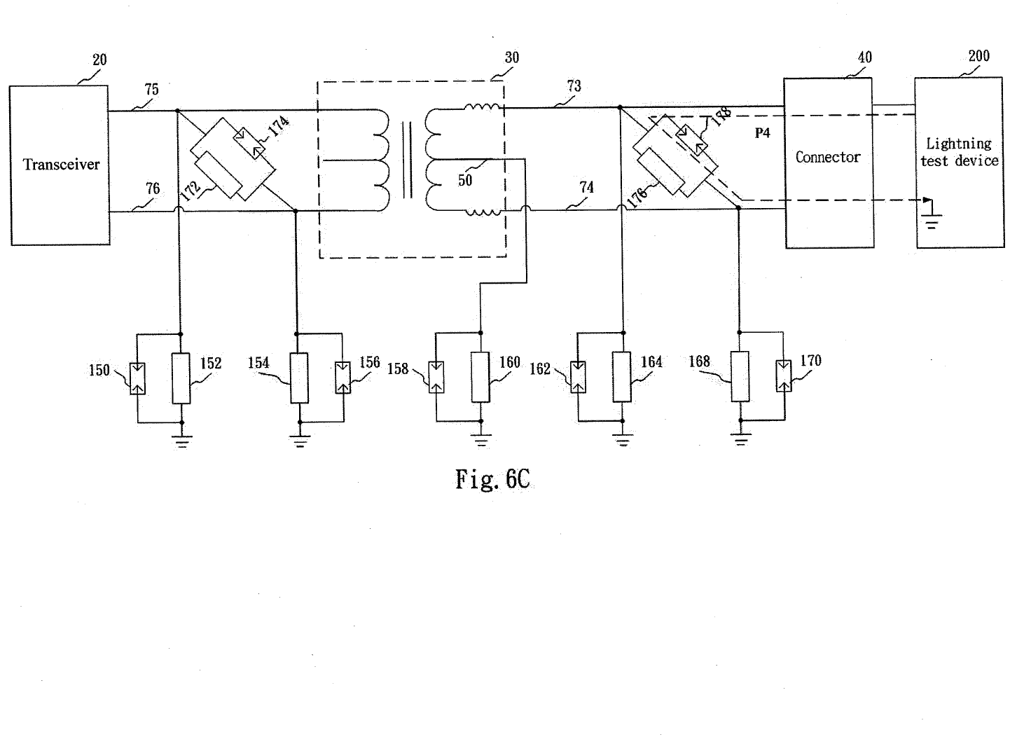

Please refer to FIG. 6A, which is an explanatory diagram of a third embodiment of a network communication device. On the primary side of transformer 30, a local network protection design may be provided by disposing one or more spark gap and transient energy trigger circuit that are coupled in parallel. For example, spark gap 150 and transient energy trigger circuit 152 are coupled in parallel between differential signal line 75 of transformer 30 and the ground end. Spark gap 156 and transient energy trigger circuit 154 are coupled in parallel between differential signal line 76 and the ground end. When the transient energy is zapping into transceiver 20, or conducted from the secondary side to the primary side of transformer 30 due to high energy, the spark gap(s) disposed at the primary side and the transient energy trigger circuit may become dissipating paths.

Furthermore, a parallel structure of spark gap 178 and transient energy trigger circuit 176 may be disposed between differential signal line 73 and differential signal line 74.

In the present embodiment, the secondary side of transformer 30 also includes: spark gap 158 and transient energy trigger circuit 160 coupled in parallel between first center tap 50 of transformer 30 and the ground end; spark gap 162 and transient energy trigger circuit 164 coupled in parallel between differential signal line 73 of transformer 30 and the ground end; spark gap 170 and transient energy trigger circuit 168 coupled in parallel between differential signal line 74 and the ground end; spark gap 178 and transient energy trigger circuit 176 coupled in parallel between differential signal line 73 and differential signal line 74.

Please refer to FIG. 6B, which is an explanatory diagram of a network communication device that applies a line-to-ground surge test to a spark gap connected with a transient energy trigger circuit in parallel. When the network is impacted by a Lightning, the transient energy is usually input from connector 40. Therefore, a surge test device 200 is used to provide the transient energy to connector 40, thereby simulating the status under a Lightning impact. Here the Lightning energy is conducted through the third dissipating path P3, from surge test device 200, connector 40 to differential signal line 73; then the sparking is caused at spark gap 162 and the transient energy is dissipated to the ground end through the spark gap and the transient energy trigger circuit.

Please refer to FIG. 6C, which is an explanatory diagram of a network communication device that applies a line-to-line surge test on a spark gap connected with a transient energy trigger circuit in parallel. When the network is impacted by a Lightning, the transient energy may be dissipated through another path. When the transient energy is input through connector 40, it may be dissipated by a fourth dissipating path P4 along the dotted line: conducted from surge test device 200, connector 40, differential signal line 73, through the sparking and connection at spark gap 178, the transient energy trigger circuit 176, and then connector 40 to the ground end of surge test device 200. In the present embodiment, multiple paths are provided to dissipate the transient energy. In fact, the possible path of the transient energy is mainly determined by the intensity of the transient energy.

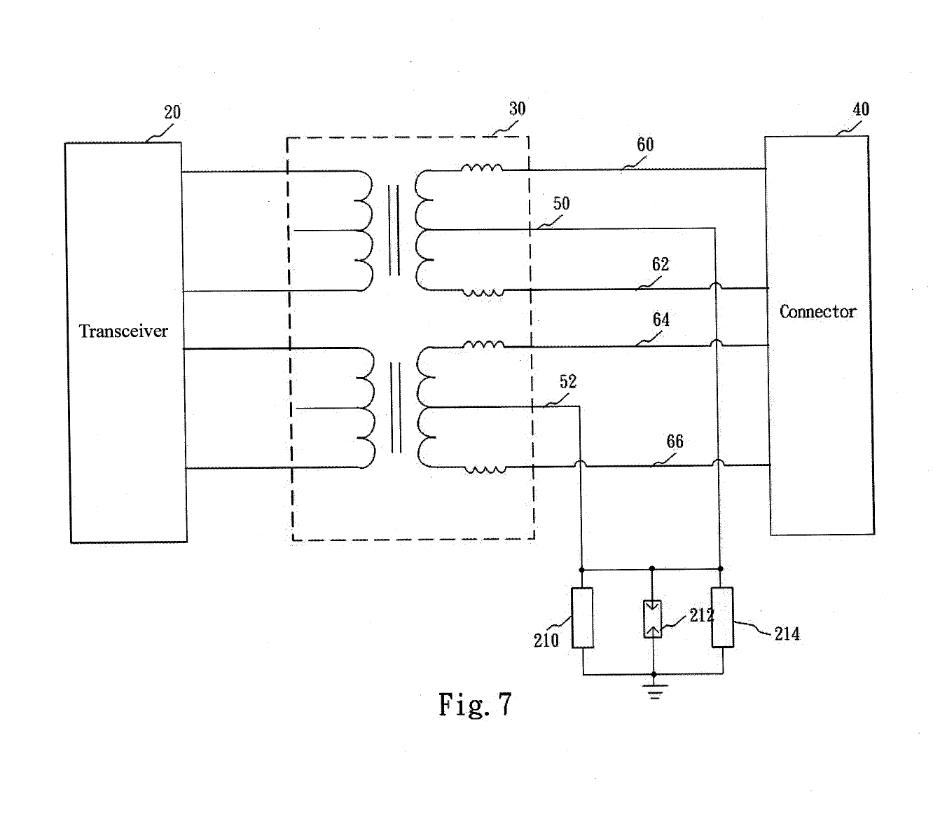

In the embodiments disclosed above, all examples are about dual dissipating paths. In FIG. 7, an embodiment is provided with triple transient energy dissipating paths. In the present embodiment, transient energy trigger circuit 210, spark gap 212 and transient energy trigger circuit 214 are coupled in parallel between first center tap 50 of transformer 30 and the ground end, and also coupled in parallel between second center tap 52 and the ground end. In other words, when transformer 30 includes multiple coil sets, spark gap 212, transient energy trigger circuit 210 and transient energy trigger circuit 214 may be coupled in parallel between the center tap of each of the coil sets and the ground end.

For the personal skilled in the art, the amount of the dissipating paths for the transient energy should not be considered as limitations to the disclosure; instead, the dissipating paths may be designed according to actual considerations of the electrical system. For example, the amount of parallel connections may be increased, or the combination of the spark gap and the transient energy trigger circuit may be changed, thereby providing various dissipating paths for the transient energy.

According to the network communication device provided in the disclosure, a new network protecting circuit board design is introduced. The spark gap is coupled in parallel with the transient energy trigger circuit to protect a local network system. Even if the transient energy is not enough to generate the sparking at the spark gap, the transient energy may still be dissipated through the transient energy trigger circuit to prevent from damages of the electrical system due to shortage of energy dissipating paths. A preferred way is to dispose the aforesaid spark gap and the transient energy trigger circuit on a PCB by means of layout.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A network communication device, comprising:
a transformer, coupled to a transceiver;
a connector, coupled to the transformer;
a transient energy trigger circuit, coupled between the transformer and a ground end; and
at least a spark gap, coupled in parallel with the transient energy trigger circuit;
wherein at a first state the transient energy trigger circuit dissipates a first transient energy to the ground end, and at a second state the spark gap dissipates a second transient energy to the ground end, the second transient energy being greater than the first transient energy.

2. The network communication device of claim 1, wherein the spark gap and the transient energy trigger circuit are coupled to a primary side of the transformer, a center tap of the primary side, a secondary side of the transformer, another center tap of the secondary side, at least one differential signal line between the transformer and the transceiver, or the at least one differential signal line between the transformer and the connector.

3. The network communication device of claim 1 further comprising:
a second transient energy trigger circuit; and
a second spark gap, coupled in parallel with the second transient energy trigger circuit between two ends of a primary side of the transformer, or between another two ends of a secondary side of the transformer.

4. The network communication device of claim 1 further comprising:
a second transient energy trigger circuit; and
a second spark gap;
wherein the second spark gap and the second transient energy trigger circuit are coupled in parallel between the ground end and a first differential signal line between the transformer and the transceiver, or coupled in parallel between the ground end and a second differential signal line between the transformer and the connector.

5. The network communication device of claim 1, wherein the ground end is a metal housing or a digital ground end.

6. The network communication device of claim 1, wherein the transient energy trigger circuit is selected from the group consisting of a diode, a gas tube, a TVS (Transient voltage suppression) diode, and a Zener diode or any combination thereof.

7. The network communication device of claim 1, wherein the transient energy trigger circuit and the spark gap is realized through layout on a printed circuit board.

8. The network communication device of claim 1, wherein the spark gap comprises multidirectional spark gap paths.

9. The network communication device of claim 1, further comprising a second transient energy trigger circuit coupled in parallel with the spark gap.

10. A printed circuit board applicable on a network communication device, the network communication device comprising a transceiver, a connector and a transformer coupled between the transceiver and the connector, the printed circuit board comprising:
a transient energy trigger circuit, coupled between the transformer and a ground end; and
at least a spark gap, coupled in parallel with the transient energy trigger circuit;
wherein at a first state the transient energy trigger circuit dissipates a first transient energy to the ground end, and at a second state the spark gap dissipates a second transient energy to the ground end, the second transient energy being greater than the first transient energy.

11. The printed circuit board of claim 10, wherein the transient energy trigger circuit and the spark gap is realized through layout on the printed circuit board.

12. The printed circuit board of claim 10, wherein the spark gap and the transient energy trigger circuit are coupled to a primary side of the transformer, a center tap of the primary side, a secondary side of the transformer, another center tap of the secondary side, at least a differential signal line between the transformer and the transceiver, or at least another differential signal line between the transformer and the connector.

13. The printed circuit board of claim 10 further comprising:
a second transient energy trigger circuit; and
a second spark gap, coupled in parallel with the second transient energy trigger circuit between two ends of a primary side of the transformer, or between another two ends of a secondary side of the transformer.

14. The printed circuit board of claim 10 further comprising:
a second transient energy trigger circuit; and
a second spark gap;
wherein the second spark gap and the second transient energy trigger circuit are coupled in parallel between the ground end and a first differential signal line between the transformer and the transceiver, or coupled in parallel between the ground end and a second differential signal line between the transformer and the connector.

15. The printed circuit board of claim 10, wherein the ground end is a metal housing or a digital ground end.

16. The printed circuit board of claim 10, wherein the transient energy trigger circuit is selected from the group consisting of a diode, a gas tube, a TVS (Transient voltage suppression) diode, and a Zener diode or any combination thereof.

17. The printed circuit board of claim 10, wherein the spark gap comprises multidirectional spark gap paths.

18. The printed circuit board of claim 10 further comprising a second transient energy trigger circuit coupled in parallel with the spark gap.

19. A network communication device, comprising:
a transformer, coupled to a transceiver;
a connector, coupled to the transformer;
a transient energy trigger circuit; and
at least a spark gap, coupled in parallel with the transient energy trigger circuit between two ends of a primary side of the transformer or between another two ends of a secondary side of the transformer;
wherein at a first state the transient energy trigger circuit dissipates a first transient energy to the ground end, and at a second state the spark gap dissipates a second transient energy to the ground end, the second transient energy being greater than the first transient energy.

20. The network communication device of claim 19, wherein the transient energy trigger circuit is selected from the group consisting of a diode, a gas tube, a TVS (Transient voltage suppression) diode, and a Zener diode or any combination thereof.

21. The network communication device of claim 19, wherein the transient energy trigger circuit and the spark gap are realized through layout on a printed circuit board.

22. The network communication device of claim 19, wherein the spark gap comprises multidirectional spark gap paths.

23. The network communication device of claim 19 further comprising a second transient energy trigger circuit coupled in parallel with the spark gap.

24. A printed circuit board applicable to a network communication device, the network communication device comprising a transceiver, a connector and a transformer coupled between the transceiver and the connector, the printed circuit board comprising:
a transient energy trigger circuit; and
at least a spark gap, coupled in parallel with the transient energy trigger circuit between two ends of a primary side of the transformer, or between another two ends of a secondary side of the transformer;
wherein at a first state the transient energy trigger circuit dissipates a first transient energy to the ground end, and at a second state the spark gap dissipates a second transient energy to the ground end, the second transient energy being greater than the first transient energy.

25. The printed circuit board of claim 24, wherein the transient energy trigger circuit is selected from the group consisting of a diode, a gas tube, a TVS (Transient voltage suppression) diode, and a Zener diode or any combination thereof.

26. The printed circuit board of claim 24, wherein the transient energy trigger circuit and the spark gap are realized through layout on the printed circuit board.

27. The printed circuit board of claim 24, wherein the spark gap comprises multidirectional spark gap paths.

28. The printed circuit board of claim 24 further comprising a second transient energy trigger circuit coupled in parallel with the spark gap.
